(19) United States
(12) Patent Application Publication
(10) Pub. No.: US 2025/0086067 A1
(43) Pub. Date: Mar. 13, 2025

(54) METHOD AND APPARATUS FOR FAST GENERATING A FULL SNAPSHOT, ELECTRONIC DEVICE AND STORAGE MEDIUM

(71) Applicant: AISHU Technology Corp., Shanghai (CN)

(72) Inventors: Suning Bao, Shanghai (CN); Han Wang, Shanghai (CN); Yong Chen, Shanghai (CN)

(21) Appl. No.: 18/288,124

(22) PCT Filed: Feb. 22, 2023
(86) PCT No.: PCT/CN2023/077531

§ 371 Date: Oct. 24, 2023

(30) Foreign Application Priority Data
Oct. 26, 2022 (CN) 202211319698.4

(51) Int. Cl. G06F 11/14; G06F 16/22

(52) U.S. Cl. CPC G06F 11/1466; G06F 11/1448; G06F 16/2282; G06F 2201/80; G06F 2201/84

(57) ABSTRACT

A method and apparatus for fast generating a full snapshot, an electronic device and a storage medium. The method includes the following: creating a source data volume and allocating a first-level data pointer table, where the first-level data pointer table records location information of multiple second-level data pointer tables; when data is written into the source data volume, determining, according to a written data offset, whether a target second-level data pointer table in which the written data is located exists and is valid; in response to determining that the target second-level data pointer table exist and is valid, writing the data into the source data volume and recording a write location of the data in the target second-level data pointer table; and when a snapshot is created, copying the first-level data pointer table as a first-level data pointer table for the snapshot.

This application claims priority to Chinese Patent Application No. 202211319698.4 filed with the China National Intellectual Property Administration (CNIPA) on Oct. 26, 2022, the disclosure of which is incorporated herein by reference in its entirety.

### TECHNICAL FIELD

Embodiments of the present application relate to the technical field of computer storage, for example, a method and apparatus for fast generating a full snapshot, an electronic device and a storage medium.

### BACKGROUND

Snapshot technology, as a kind of technology widely applied in the field of computers, is one fully usable copy of a designated data set. The copy contains a still image of source data at a point in time of copy.

Common techniques for snapshots include copy-on-write (COW) and redirect-on-write (ROW).

In the preceding two manners of the snapshot technology, when a snapshot is created, a source data pointer table needs to be copied. When the volume is greatly large, the space occupied by the source data pointer table is also relatively large, and the copy may take a relatively long time.

### SUMMARY

The present application provides a method and apparatus for fast generating a full snapshot, an electronic device and a storage medium to avoid the case that when the snapshot technology applied in the related art has a greatly large volume, the space occupied by a source data pointer table is also relatively large, and the copy takes a relatively long time.

According to an aspect of the present application, a method for fast generating a full snapshot is provided. The method includes the steps below.

A source data volume is created, and a first-level data pointer table is allocated. The first-level data printer table records location information of multiple second-level data pointer tables, and the multiple second-level data pointer tables record location information of data blocks.

When data is written into the source data volume, whether a target second-level data pointer table in which the written data is located exists and whether the target second-level data pointer table is valid are determined according to a written data offset.

In response to determining that the target second-level data pointer table exists and is valid, the data is written into the source data volume, and a write location of the data is recorded in the target second-level data pointer table.

When a snapshot is created, the first-level data pointer table is copied as a first-level data pointer table for the snapshot.

According to another aspect of the present application, an apparatus for fast generating a full snapshot is provided. The apparatus includes a creation module, a determination module, a write module and a snapshot module.

The creation module is configured to create a source data volume and allocate a first-level data pointer table. The first-level data printer table records location information of multiple second-level data pointer tables, and the multiple second-level data pointer tables record location information of a data block.

The determination module is configured to, when data is written into the source data volume, determine, according to a written data offset, whether a target second-level data pointer table in which the written data is located exists and is valid.

The write module is configured to, in response to determining that the target second-level data pointer table exists and is valid, write the data into the source data volume and record a write location of the data in the target second-level data pointer table.

The snapshot module is configured to, when a snapshot is created, copy the first-level data pointer table as a first-level data pointer table for the snapshot.

According to another aspect of the present application, an electronic device is provided. The electronic device includes at least one processor and a memory communicatively connected to the at least one processor.

The memory stores a computer program executable by the at least one processor, and the computer program is executed by the at least one processor to cause the at least one processor to perform the method for fast generating a full snapshot according to any one of embodiments of the present application.

According to another aspect of the present application, a computer-readable storage medium is provided. The computer-readable storage medium stores computer instructions which, when executed by a processor, are configured to cause the processor to perform the method for fast generating a full snapshot according to any one of embodiments of the present application

### BRIEF DESCRIPTION OF DRAWINGS

FIG. 1 is a flowchart of a method for fast generating a full snapshot according to an embodiment of the present application.

FIG. 2 is a flowchart of a method for fast generating a full snapshot according to another embodiment of the present application.

FIG. 3 is a diagram illustrating fast generation of a full snapshot according to an example embodiment of the present application.

FIG. 4 is a flowchart of data writing after a snapshot is created in a method for fast generating a full snapshot according to an example embodiment of the present application.

FIG. 5 is a diagram illustrating the structure of an apparatus for fast generating a full snapshot according to an embodiment of the present application.

FIG. 6 is a diagram illustrating the structure of an electronic device for a method for fast generating a full snapshot according to an embodiment of the present application.

### DETAILED DESCRIPTION

As used herein, the term “include” and variations thereof are intended to be inclusive, that is, “including, but not limited to”. The term “based on” is “at least partially based on”. The term “one embodiment” means “at least one embodiment”: the term “another embodiment” means “at least one another embodiment”; and the term “some embodiments” means “at least some embodiments”. Related definitions of other terms are given in the description hereinafter.

It is to be noted that the terms “first”, “second” and the like in the description, claims and drawings of the present application are used for distinguishing between similar objects and are not necessarily used for describing a particular order or sequence. It should be understood that the data used in this manner is interchangeable where appropriate so that embodiments of the present application described herein may also be implemented in a sequence not illustrated or described herein. In addition, the terms “comprising”, “including” and any other variations thereof are intended to encompass a non-exclusive inclusion. For example, a process, method, system, product or device that includes a series of steps or units not only includes the expressly listed steps or units but may also include other steps or units that are not expressly listed or are inherent to such process, method, product or device.

It is to be noted that “one” and “a plurality” mentioned in the present application are illustrative and not limiting, and that those skilled in the art should understand that “one” and “a plurality” should be understood as “one or more” unless clearly expressed in the context.

The names of messages or information exchanged between apparatuses in embodiments of the present application are illustrative and not to limit the scope of the messages or information. Common techniques for snapshots include the COW and ROW.

In COW snapshots, each source data volume has a data pointer table, that is, a source data pointer table. Each item in the table records physical location information of a respective source data block. When a snapshot is created, a duplicate of the source data pointer table is copied and used as a data pointer table of a snapshot volume, and the copied duplicate is short for a snapshot data pointer table. When data in a data block of the source volume changes, original data is first copied to the snapshot volume, the respective item in the snapshot pointer table is simultaneously modified to point to the copied data, and then the source volume is overwritten. When a snapshot is recreated, the source data pointer table is recopied, and the new modification is recorded in the old snapshot volume and the new snapshot volume.

The disadvantages of the COW snapshots are as follows: at least two writing operations are performed for each first data update, that is, one is copying and writing the original data into the snapshot volume, and the other is overwriting the new data; and as the number of snapshots increases, it takes a longer time to create a snapshot over time, because when data of the source volume is modified each time, data pointer tables of all previous snapshots need to be updated.

The implementation principles of ROW snapshots are similar to that of the COW except that after the snapshot is created, if a modification is made to the source volume data block, new data is directly written into the snapshot volume, and the respective item in the snapshot data pointer table is updated to point to the new data. If the snapshot is recreated, the source data pointer table is recopied, and the new data is written into the new snapshot. To ensure data consistency, the ROW snapshots must be chained, and reading data from subsequent snapshots requires the previous snapshots as the basis.

The disadvantages of the ROW snapshots are as follows: each snapshot cannot exist independently and needs to cooperate with the previous snapshots, and the more snapshots are created, the deeper the snapshot levels are, and the higher the overhead of snapshot reading is; and when a snapshot is deleted, the data needs to be copied back to the source volume, taking too much time.

Based on the shortcomings of the snapshot technology in the related art, embodiments of the present application provide a method for fast generating a full snapshot.

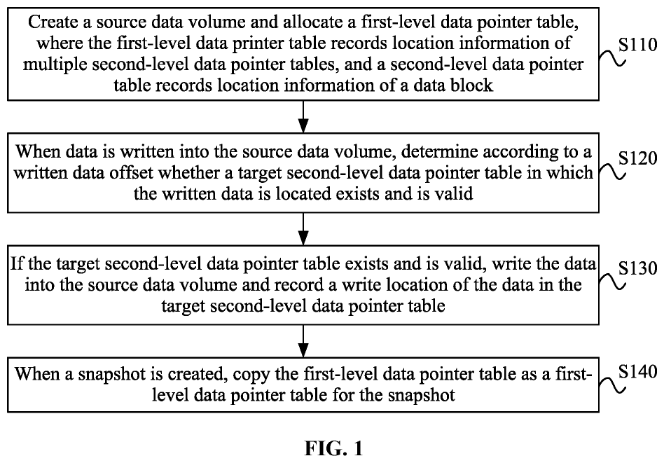

FIG. 1 is a flowchart of a method for fast generating a full snapshot according to an embodiment of the present application. The method is applicable to the case of data storage. The method may be executed by an apparatus for fast generating a full snapshot. The apparatus may be implemented by software and/or hardware and is generally integrated in an electronic device. In this embodiment, the electronic device includes, but is not limited to, a computer device.

As shown in FIG. 1, the method for fast generating a full snapshot according to an embodiment of the present application includes the steps below.

In S110, a source data volume is created, and a first-level data pointer table is allocated. The first-level data printer table records location information of multiple second-level data pointer tables, and a second-level data pointer table records location information of a data block.

A data volume is one special directory usable by one or more containers and directly maps a host operating system directory into the container. The source data volume may be created on a disk. Each disk may be divided into multiple logical data blocks for data storage according to a preset size. Exemplarily, each disk may be divided into multiple logical data blocks according to 1 MB.

Exemplarily, each 1-MB logical data block may be uniquely marked by using a disk serial number (8 bytes) and a serial number (8 bytes) of the data block in the disk, so each data block needs to be marked by using 16 bytes.

In this embodiment, when the source data volume is created, the first-level data pointer table may be allocated according to the size of the data volume, and the content of the first-level data pointer table is reset. Exemplarily, one first-level data pointer table may represent a 4 PB space.

The first-level data pointer table may be understood as a continuous address space allocated to the source data volume when the source data volume is created. Each item in the address space records the location information of a second-level data pointer table. One source data volume has only one first-level data pointer table. The size of the first-level data pointer table may be set according to the size of the source data volume. The first-level data pointer table indexes the data space of the entire source data volume.

It is to be noted that the first-level data pointer table of the source data volume records the location information of the second-level data pointer tables of the source data volume. The second-level data pointer table may be understood as the indexes for data within a continuous space range in the source data volume. Each item in the second-level data pointer table records the location information of one data block.

In S120, when data is written into the source data volume, it is determined according to a written data offset whether a target second-level data pointer table in which the written data is located exists and whether the target second-level data pointer table is valid.

The written offset may be understood as a location offset when the data is written into the source data volume. The target second-level data pointer table may be understood as a second-level data pointer table to which the written data belongs.

In this embodiment, when the data is written into the source data volume, whether the second-level data pointer table in which the written data is located exists and is valid needs to be determined first. The process of determining according to the written data offset whether the target second-level data pointer table in which the written data is located exists and is valid is not described herein.

In S130, if the target second-level data pointer table exists and is valid, the data is written into the source data volume, and a write location of the data is recorded in the target second-level data pointer table.

In this embodiment, if the second-level data pointer table in which the written data is located exists and is valid, the data may be directly written, and the write location of the data is updated to the second-level data pointer table.

If it is determined that the second-level data pointer table (the target second-level data pointer table) to which the written data belongs does not exist, or that the second-level data pointer table (the target second-level data pointer table) to which the written data belongs exists but is invalid, one second-level data pointer table may be reallocated, and location information of the newly-allocated second-level data pointer table is updated to the first-level data pointer table so that the location information of the second-level data pointer table is recorded in the first-level data pointer table. When the data is written into the source data volume, the write location of the data may be updated to the newly-allocated second-level data pointer table to enable the newly-allocated second-level data pointer table to include the location information of the written data.

The second-level data pointer table includes multiple second-level data pointer table items. That is, the second-level data pointer table may be understood as a set of multiple second-level data pointer table items.

In S140, when a snapshot is created, the first-level data pointer table is copied as a first-level data pointer table for the snapshot.

Snapshot creation may be understood as data backup. In this embodiment, when the snapshot is created, only the first-level data pointer table of the source data volume needs to be copied as the first-level data pointer table for the snapshot.

In the method for fast generating a full snapshot according to this embodiment of the present application, first, the source data volume is created, and the first-level data pointer table is allocated, where the first-level data pointer table records the location information of the multiple second-level data pointer tables, and the second-level data pointer table records the location information of the data block: second, when the data is written into the source data volume, whether the target second-level data pointer table in which the written data is located exists and is valid is determined according to the written data offset: then, if the target second-level data pointer table exists and is valid, the data is written into the source data volume, and the write location of the data is recorded in the target second-level data pointer table: finally, when the snapshot is created, the first-level data pointer table is copied as the first-level data pointer table for the snapshot. In the preceding method, since the first-level data pointer table stores the location information of the second-level data pointer tables, in a case where the volume is extremely large, for example, the volume has hundreds of TBs or is even larger, the snapshot can also be fast created without copying all the second-level data pointer tables.

In an embodiment, when the data is read, a second-level data pointer table in which the reading location is located is determined according to the first-level data pointer table of the source data volume or the first-level data pointer table of the snapshot, a location of the read data is determined from the second-level data pointer table in which the reading location is located, and the data is read from the location.

When the data is read, the location of the data needs to be learned. The location of the data is recorded in the second-level data pointer table. The location of the second-level data pointer table may be acquired from the first-level data pointer table of the source data volume or the first-level data pointer table of the snapshot. The location of the read data block may be learned from the second-level data pointer table, and thereby the data may be read from the location.

In an embodiment, the method for fast generating a full snapshot further includes that the snapshot is deleted by directly deleting the first-level data pointer table of the snapshot.

In this embodiment, when the snapshot is deleted, the first-level data pointer table of the snapshot is directly deleted. It is to be noted that the resource data volume and the snapshot exist independently, so deleting one of the two does not affect the presence of the other one.

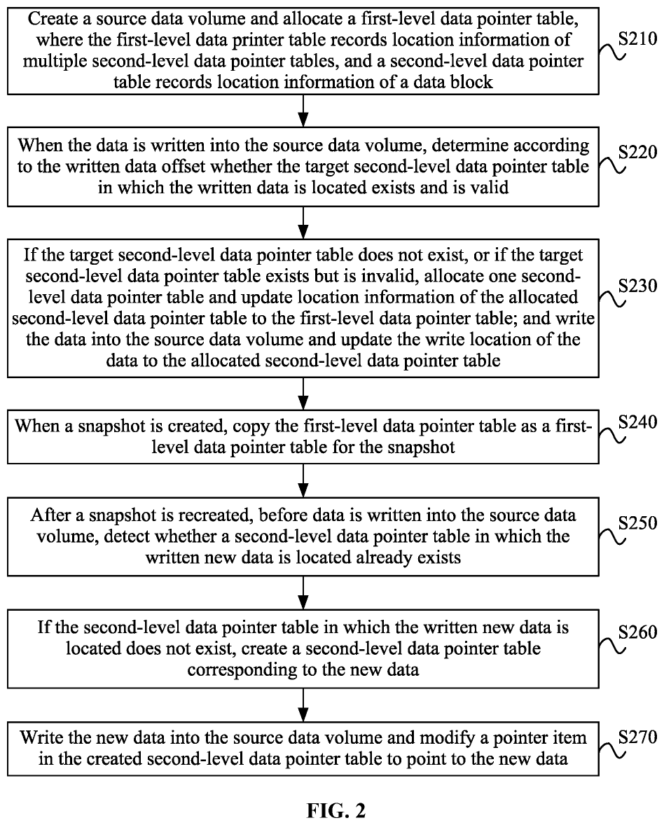

FIG. 2 is a flowchart of a method for fast generating a full snapshot according to another embodiment of the present application. This embodiment is refined based on the preceding embodiment. For the content not yet exhaustive in this embodiment, reference may be made to the preceding embodiment.

As shown in FIG. 2, the method for fast generating a full snapshot according to another embodiment of the present application includes the steps below:

In S210, the source data volume is created, and the first-level data pointer table is allocated. The first-level data printer table records the location information of multiple second-level data pointer tables, and the second-level data pointer table records the location information of the data block.

In S220, when the data is written into the source data volume, whether the target second-level data pointer table in which the written data is located exists and whether the target second-level data pointer table is valid are determined according to the written data offset.

In S230, if the target second-level data pointer table does not exist, or if the target second-level data pointer table exists but is invalid, one second-level data pointer table is allocated, and location information of the allocated second-level data pointer table is updated to the first-level data pointer table; and the data is written into the source data volume, and the write location of the data is updated to the allocated second-level data pointer table.

If the target second-level data pointer table exists and is valid, the data is written into the source data volume, and the write location of the data is recorded in the target second-level data pointer table.

In S240, when the snapshot is created, the first-level data pointer table is copied as the first-level data pointer table for the snapshot.

In S250, after a snapshot is recreated, and before data writing is performed on the source data volume, it is detected whether a second-level data pointer table in which the written new data is located already exists.

In this embodiment, when the snapshot is recreated, the first-level data pointer table of the source data volume is recopied, and the written new data is recorded in the source data volume. After the snapshot is recreated, before the data writing is performed on the source data volume, it needs to be first detected in the first-level data pointer table of the source data volume whether the second-level data pointer table to which the newly-written data belongs already exists.

In S260, if the second-level data pointer table in which the written new data is located does not exist, a second-level data pointer table corresponding to the new data is created.

In S270, the new data is written into the source data volume, and a pointer item in the created second-level data pointer table is modified to point to the new data.

After the new data is written, a first-level data pointer table item of the source data volume needs to be modified to enable the first-level data pointer table item to point to the created second-level data pointer table. The first-level data pointer table includes multiple first-level data pointer table items. That is, the first-level data pointer table may be understood as a set of multiple first-level data pointer table items.

In an embodiment, if the second-level data pointer table in which the written new data is located exists, the second-level data pointer table is copied to obtain a newly-created second-level data pointer table, and the first-level data pointer table item of the source data volume is modified to point to the newly-created second-level data pointer table: whether a data block corresponding to the new data is already allocated is looked up in the newly-created second-level data pointer table: if the data block corresponding to the new data is already allocated, the original data in the source data volume is copied, the original data and the new data are merged, the merged data is written into the source data volume, and the newly-created second-level data pointer table in the source data volume is updated to point to the merged data block.

The newly-created second-level data pointer table may be understood as a second-level data pointer table newly created and may serve as a second-level data pointer table of the source data volume.

In this embodiment, if the second-level data pointer table in which the written new data is located exists, the second-level data pointer table to which the new data belongs is copied to obtain one duplicate serving as the second-level data pointer table of the source data volume, and the first-level data pointer table item of the source data volume is modified to point to the newly-created second-level data pointer table obtained by copy.

In this embodiment, before the data writing, whether the data block is already allocated is first detected in the newly-created second-level data pointer table: if the data block is already allocated, the original data needs to be first copied, the original data obtained by copy and the written new data are merged, then the merged data is written into the source data volume, and the write location of the merged data is updated to a second-level data pointer table item of the source data volume to point to the merged data. Whether the data block is already allocated may be determined according to the validity of the pointer table item.

In an embodiment, if the data block corresponding to the new data is not allocated, the new data is directly written into the source data volume, and the location information of the new data is updated to the second-level data pointer tables of the source data volume.

In the method for fast generating a full snapshot according to this embodiment of the present application, the data writing process when the snapshot is recreated is refined. Compared with the COW snapshots in the related art, the present method only needs one write operation for each first data update, that is, after the original data is copied, the original data and the written new data are merged and then written into the source data volume. Moreover, an increase in snapshots does not affect the performance of snapshot creation, and each snapshot creation only needs to copy the first-level data pointer table of the source data volume, without any change to the historical snapshots. Compared with the ROW snapshots in the related art, the present method writes the new data into the source volume, each time a snapshot is created, the first-level data pointer table of the source data volume is copied, and each snapshot is an independent and complete duplicate and has no relationship with the source data volume and previous snapshots, so there are no chained levels, and the overhead of snapshot reading is not affected. Moreover, the data pointer table content copied during snapshot creation is reduced through two layers of data pointer tables, and for an extremely large volume, the time of snapshot creation is greatly shortened, and the ability of real-time snapshots can be achieved.

This embodiment of the present application provides an example embodiment based on the technical schemes of the preceding embodiments.

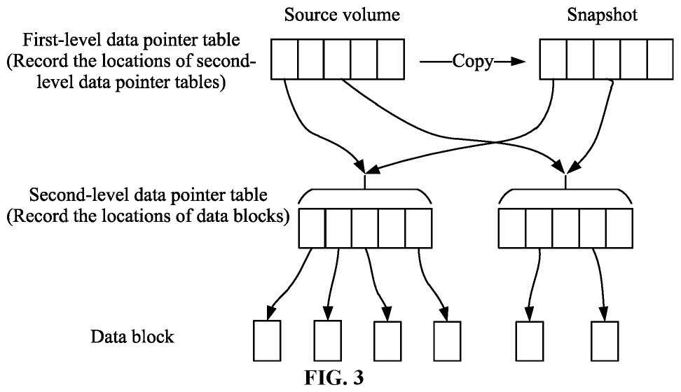

FIG. 3 is a diagram illustrating fast generation of a full snapshot according to an example embodiment of the present application. The fast generation of a full snapshot is completed through the first-level data pointer table and the second-level data pointer tables.

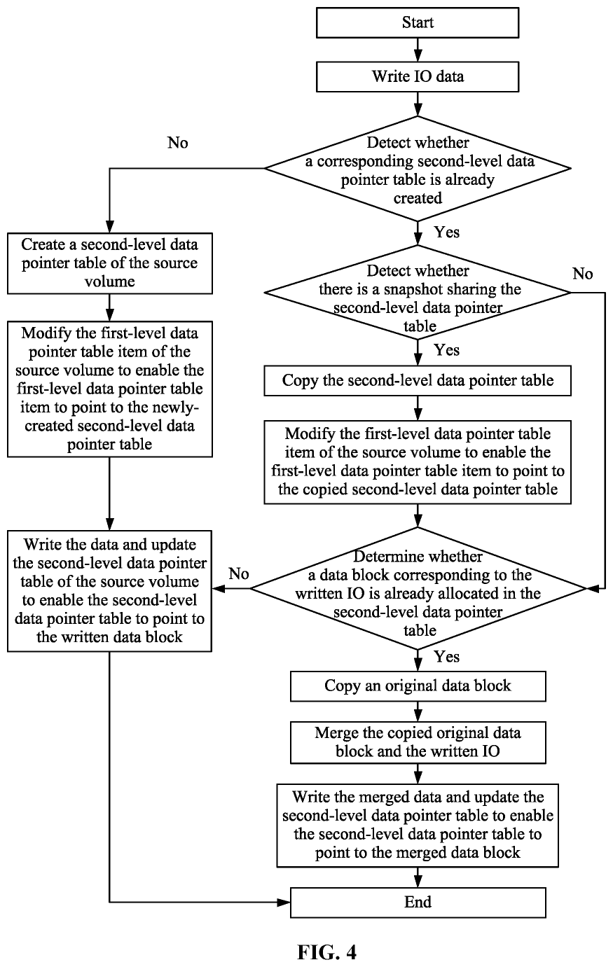

FIG. 4 is a flowchart of data writing after a snapshot is created in a method for fast generating a full snapshot according to an example embodiment of the present application. As shown in FIG. 4, the flow includes the following: Input/output (IO) data is written: whether a second-level data pointer table corresponding to the IO data is already created is detected: if the second-level data pointer table corresponding to the IO data is not created, a second-level data pointer table of the source volume, that is, the source data volume, is created, and the first-level data pointer table item of the source volume is modified to point to the newly-created second-level data pointer table: the data is written, and the second-level data pointer table of the source volume is updated.

The flow further includes the following: If the second-level data pointer table corresponding to the IO data is already created, whether there is a snapshot sharing the second-level data pointer table is detected: if there is a snapshot sharing the second-level data pointer table, the second-level data pointer table is copied, and the first-level data pointer table item of the source volume is modified to point to the copied second-level data pointer table: whether a data block corresponding to the written IO data is already allocated in the second-level data pointer table is determined: if the data block corresponding to the written IO data is already allocated in the second-level data pointer table, the original data block is copied, the copied original data block and the written IO data are merged, the merged data is written, and the second-level data pointer table is updated to point to the merged data block; and if the data block corresponding to the written IO data is not allocated in the second-level data pointer table, the data is directly written, and the second-level data pointer table of the source volume is updated.

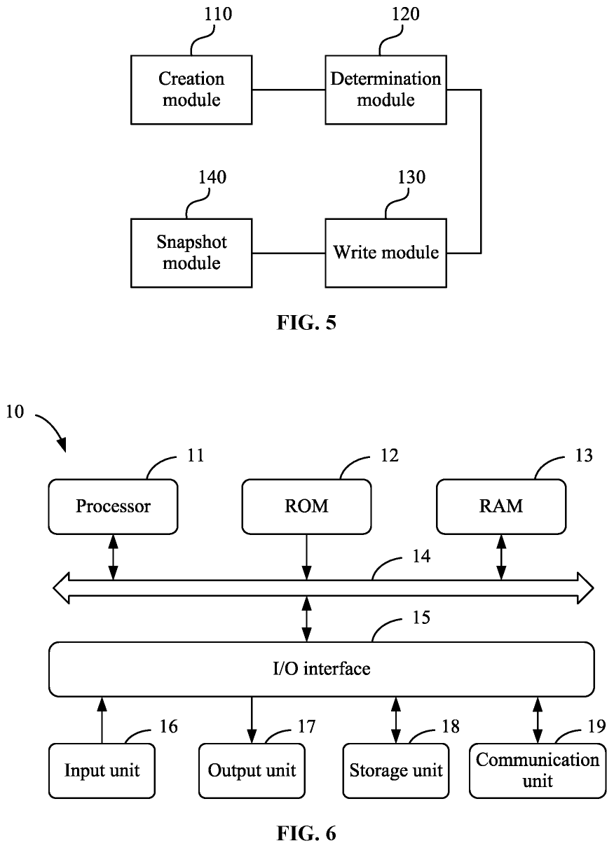

FIG. 5 is a diagram illustrating the structure of an apparatus for fast generating a full snapshot according to an embodiment of the present application. The apparatus is applicable to the case of data storage. The apparatus may be implemented by software and/or hardware and is generally integrated in an electronic device.

As shown in FIG. 5, the apparatus includes a creation module 110, a determination module 120, a write module 130 and a snapshot module 140.

The creation module 110 is configured to create a source data volume and allocate a first-level data pointer table. The first-level data printer table records location information of multiple second-level data pointer tables, and a second-level data pointer table records location information of a data block.

The determination module 120 is configured to, when data is written into the source data volume, determine whether a target second-level data pointer table in which the written data is located exists and is valid according to a written data offset.

The write module 130 is configured to, in response to determining that the target second-level data pointer table exists and is valid, write the data into the source data volume and record a write location of the data in the target second-level data pointer table.

The snapshot module 140 is configured to, when a snapshot is created, copy the first-level data pointer table as a first-level data pointer table for the snapshot.

In this embodiment, the apparatus first creates the source data volume and allocates the first-level data pointer table through the creation module 110, where the first-level data pointer table records the location information of the multiple second-level data pointer tables, and the second-level data pointer table records the location information of the data block. Secondly, when the data is written into the source data volume, the apparatus determines whether the target second-level data pointer table in which the written data is located exists and is valid through the determination module 120 according to the written data offset: then if the target second-level data pointer table exists and is valid, the apparatus writes the data into the source data volume and record the write location of the data in the target second-level data pointer table through the write module 130; and finally, when the snapshot is created, the apparatus copies the first-level data pointer table as the first-level data pointer table for the snapshot through the snapshot module 140.

This embodiment provides an apparatus for fast generating a full snapshot that can fast create snapshots on an extremely large volume.

For example, the apparatus further includes an allocation module. The allocation module is configured to, if the target second-level data pointer table does not exist, or if the target second-level data pointer table exists but is invalid, allocate one second-level data pointer table and update location information of the allocated second-level data pointer table to the first-level data pointer table; and write the data into the source data volume and update the location, in which the data is written, to the allocated second-level data pointer table.

For example, the apparatus further includes a recreation module. The recreation module includes a detection unit, a first creation unit and a second creation unit.

The detection unit is configured to, after a snapshot is recreated, before data is written into the source data volume, detect whether a second-level data pointer table in which the written new data is located already exists.

The first creation unit is configured to, if the second-level data pointer table in which the written new data is located does not exist, create a second-level data pointer table corresponding to the new data, write the new data into the source data volume and modify a pointer item in the created second-level data pointer table to point to the new data.

The second creation unit is configured to, if the second-level data pointer table in which the written new data is located exists, copy the second-level data pointer table to obtain a newly-created second-level data pointer table and modify a first-level data pointer table item of the source data volume to enable the first-level data pointer table item to point to the newly-created second-level data pointer table.

For example, the second creation unit is further configured to look up, in the newly-created second-level data pointer table, whether a data block corresponding to the new data is already allocated: if the data block corresponding to the new data is already allocated, copy original data in the source data volume, merge the original data and the new data, write the merged data into the source data volume and update the newly-created second-level data pointer table in the source data volume to enable the updated second-level data pointer tables to point to the merged data block: alternatively, if the data block corresponding to the new data is not allocated, the second creation unit is further configured to directly write the new data into the source data volume and update location information of the new data to the newly-created second-level data pointer table of the source data volume.

For example, the apparatus further includes a reading module. The reading module is configured to, when the data is read, determine a second-level data pointer table in which reading location is located according to the first-level data pointer table of the source data volume or the first-level data pointer table of the snapshot, determine a location of the read data from the second-level data pointer table in which the reading location is located, and read the data from the location.

For example, the apparatus further includes a snapshot deletion module. The snapshot deletion module is configured to delete the snapshot by directly deleting the first-level data pointer table of the snapshot.

The preceding apparatus for fast generating a full snapshot may execute the method for fast generating a full snapshot according to any one of embodiments of the present application and has functional modules and beneficial effects corresponding to the executed method.

FIG. 6 is a diagram illustrating the structure of an electronic device 10 for implementing embodiments of the present application. The electronic device is intended to represent various forms of digital computers, for example, a laptop computer, a desktop computer, a worktable, a personal digital assistant, a server, a blade server, a mainframe computer, or another applicable computer. The electronic device may also represent various forms of mobile apparatuses, for example, a personal digital assistant, a cellphone, a smartphone, a wearable device (such as a helmet, glasses, or a watch), or other similar computing apparatuses. Herein the shown components, the connections and relationships between these components, and the functions of these components are merely illustrative and are not intended to limit the implementation of the present application as described and/or claimed herein.

As shown in FIG. 6, the electronic device 10 includes at least one processor 11 and a memory, such as a read-only memory (ROM) 12 or a random-access memory (RAM) 13, communicatively connected to the at least one processor 11. The memory stores a computer program executable by the at least one processor. The at least one processor 11 may perform various types of appropriate operations and processing according to a computer program stored in a read-only memory (ROM) 12 or a computer program loaded from a storage unit 18 to a random-access memory (RAM) 13. The RAM 13 may also store various programs and data required for the operation of the electronic device 10. The at least one processor 11, the ROM 12 and the RAM 13 are connected to each other through a bus 14. An input/output (I/O) interface 15 is also connected to the bus 14.

Multiple components in the electronic device 10 are connected to the I/O interface 15. The multiple components include an input unit 16 such as a keyboard or a mouse, an output unit 17 such as various types of displays and speakers, the storage unit 18 such as a magnetic disk or an optical disk, and a communication unit 19 such as a network card, a modem or a wireless communication transceiver. The communication unit 19 allows the electronic device 10 to exchange information/data with other devices over a computer network such as the Internet and/or various telecommunications networks.

The at least one processor 11 may be various general-purpose and/or special-purpose processing components having processing and computing capabilities. Some examples of the processor 11 include, but are not limited to, a central processing unit (CPU), a graphics processing unit (GPU), a special-purpose artificial intelligence (AI) computing chip, a processor executing machine learning models and algorithms, a digital signal processor (DSP), and any appropriate processor, controller and microcontroller. The at least one processor 11 performs various preceding methods and processing, such as the method for fast generating a full snapshot. In some embodiments, the method for fast generating a full snapshot may be implemented as computer programs tangibly contained in a computer-readable storage medium such as the storage unit 18. In some embodiments, part or all of computer programs may be loaded and/or installed onto the electronic device 10 via the ROM 12 and/or the communication unit 19. When the computer programs are loaded to the RAM 13 and executed by the at least one processor 11, one or more steps of the preceding method for fast generating a full snapshot may be performed.

Alternatively, in other embodiments, the at least one processor 11 may be configured, in any other suitable manners (for example, by virtue of firmware), to perform the method for fast generating a full snapshot.

Herein various embodiments of the systems and techniques described in the preceding may be implemented in digital electronic circuitry, integrated circuitry; field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. These various embodiments may include implementations in one or more computer programs. The one or more computer programs are executable and/or interpretable on a programmable system including at least one programmable processor. The at least one programmable processor may be a special-purpose or general-purpose programmable processor for receiving data and instructions from a storage system, at least one input apparatus and at least one output apparatus and transmitting data and instructions to the storage system, the at least one input apparatus and the at least one output apparatus.

Computer programs for implementation of the methods of the present application may be written in one programming language or any combination of multiple programming languages. These computer programs may be provided for a processor of a general-purpose computer, a special-purpose computer or another programmable data processing apparatus such that these computer programs, when executed by the processor, cause functions/operations specified in the flowcharts and/or block diagrams to be implemented. These computer programs may be executed entirely on a machine, partly on a machine, as a stand-alone software package, partly on a machine and partly on a remote machine, or entirely on a remote machine or a server.

In the context of the present application, the computer-readable storage medium may be a tangible medium including or storing a computer program that is used by or used in conjunction with an instruction execution system, apparatus, or device. The computer-readable storage medium may include, but is not limited to, an electronic, magnetic, optical, electromagnetic, infrared or semiconductor system, apparatus or device, or any suitable combination thereof. Alternatively, the computer-readable storage medium may be a machine-readable signal medium. More specific examples of the machine-readable storage medium may include an electrical connection with one or more wires, a portable computer disk, a hard disk, a random-access memory (RAM), a read-only memory (ROM), an erasable programmable read-only memory (EPROM or a flash memory), an optical fiber, a portable compact disc read-only memory (CD-ROM), an optical storage device, a magnetic storage device, or any appropriate combination thereof. The computer-readable storage medium may be a non-transitory computer-readable storage medium.

In order that interaction with a user is provided, the systems and techniques described herein may be implemented on the electronic device. The electronic device has a display device (for example, a cathode-ray tube (CRT) or a liquid-crystal display (LCD) monitor) for displaying information to the user, and a keyboard and a pointing device (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a user computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server avoids the problem of difficult management and weak service scalability in the service of a physical host and a related virtual private server (VPS) in the related art.

It is to be understood that various forms of the preceding flows may be used with steps reordered, added, or removed. For example, the steps described in the present application may be executed in parallel, in sequence or in a different order as long as the desired results of the technical solutions in the present application are achieved. The execution sequence of these steps is not limited herein.

In the technical schemes of the embodiments of the present application, the source data volume is created, and the first-level data pointer table is allocated, where the first-level data pointer table records the location information of the multiple second-level data pointer tables, and the second-level data pointer table records the location information of the data block: when data is written into the source data volume, whether the target second-level data pointer table in which the written data is located exists and is valid is determined according to the written data offset: if the target second-level data pointer table exists and is valid, the data is written into the source data volume, and the write location of the data is recorded in the target second-level data pointer table; and when the snapshot is created, the first-level data pointer table is copied as the first-level data pointer table for the snapshot. In the method, the data blocks of the volume are indexed through two layers of data pointer tables, and the source data volume is used for recording the latest changed data, so fast snapshot creation can be performed on an extremely large volume, thereby avoiding the situation that when the snapshot technology in the related art has a greatly large volume, the space occupied by pointer tables of the source data is also relatively large, the copy takes a relatively long time.

1. A method for fast generating a full snapshot, comprising:
creating a source data volume and allocating a first-level data pointer table, wherein the first-level data printer table records location information of a plurality of second-level data pointer tables, and the plurality of second-level data pointer tables record location information of a data block;
when data is written into the source data volume, determining, according to a written data offset, whether a target second-level data pointer table in which the written data is located exists in the plurality of second-level data pointer tables and whether the target second-level data pointer table is valid;
in response to determining that the target second-level data pointer table exists and is valid, writing the data into the source data volume and recording a write location of the data in the target two-level data pointer table; and
when a snapshot is created, copying the first-level data pointer table as a first-level data pointer table for the snapshot.

2. The method according to claim 1, further comprising:
in response to determining that the target second-level data pointer table does not exist, or that the target second-level data pointer table exists but is invalid, allocating one second-level data pointer table in the plurality of second-level data pointer tables and updating location information of the allocated second-level data pointer table to the first-level data pointer table; and
writing the data into the source data volume and updating the write location of the data to the allocated second-level data pointer table.

3. The method according to claim 1, further comprising:
after the snapshot is recreated, before data is written into the source data volume, detecting whether a second-level data pointer table in which the written new data is located already exists;
in response to determining that the second-level data pointer table in which the written new data is located does not exist, creating a second-level data pointer table corresponding to the new data; and
writing the new data into the source data volume and modifying a pointer item in the created second-level data pointer table to point to the new data.

4. The method according to claim 3, further comprising:
in response to determining that the second-level data pointer table in which the written new data is located exists, copying the second-level data pointer table to obtain a newly-created second-level data pointer table, and modifying a first-level data pointer table item of the source data volume to enable the modified first-level data pointer table item of the source data volume to point to the newly-created second-level data pointer table;
looking up, in the newly-created second-level data pointer table, whether a data block corresponding to the new data is already allocated; and
in response to determining that the data block corresponding to the new data is already allocated, copying original data in the source data volume, merging the original data and the new data, writing merged data into the source data volume, and updating the newly-created second-level data pointer table in the source data volume to enable the updated second-level data pointer table in the source data volume to point to the merged data block.

5. The method according to claim 4, further comprising:
in response to determining that the data block corresponding to the new data is not allocated, directly writing the new data into the source data volume and updating location information of the new data to the newly-created second-level data pointer table of the source data volume.

6. The method according to claim 1, further comprising:
when the data is read, determining a second-level data pointer table in which a reading location is located according to the first-level data pointer table of the source data volume or the first-level data pointer table of the snapshot, determining, from the second-level data pointer table in which the reading location is located, a location of the read data, and reading the data from the location.

7. The method according to claim 1, further comprising:
deleting the snapshot by directly deleting the first-level data pointer table of the snapshot.

8. An apparatus for fast generating a full snapshot, comprising:
a creation module configured to create a source data volume and allocate a first-level data pointer table, wherein the first-level data printer table records location information of a plurality of second-level data pointer tables, and the plurality of second-level data pointer tables record location information of a data block;
a determination module configured to, when data is written into the source data volume, determine, according to a written data offset, whether a target second-level data pointer table in which the written data is located exists in the plurality of second-level data pointer tables and whether the target second-level data pointer table is valid;
a write module configured to, in response to determining that the target second-level data pointer table exists and is valid, write the data into the source data volume and record a write location of the data in the target second-level data pointer table; and
a snapshot module configured to, when a snapshot is created, copy the first-level data pointer table as a first-level data pointer table for the snapshot.

9. An electronic device, comprising:
at least one processor; and
a memory communicatively connected to the at least one processor,
wherein the memory stores a computer program executable by the at least one processor, and the computer program is executed by the at least one processor to cause the at least one processor to perform the following:
creating a source data volume and allocating a first-level data pointer table, wherein the first-level data printer table records location information of a plurality of second-level data pointer tables, and the plurality of second-level data pointer tables record location information of a data block;
when data is written into the source data volume, determining, according to a written data offset, whether a target second-level data pointer table in which the written data is located exists in the plurality of second-level data pointer tables and whether the target second-level data pointer table is valid;
in response to determining that the target second-level data pointer table exists and is valid, writing the data into the source data volume and recording a write location of the data in the target two-level data pointer table; and
when a snapshot is created, copying the first-level data pointer table as a first-level data pointer table for the snapshot.

10. A non-transitory computer-readable storage medium storing computer instructions which, when executed by a processor, are configured to cause the processor to perform the method for fast generating a full snapshot according to claim 1.

11. The electronic device according to claim 9, wherein the at least one processor is caused to further perform:
in response to determining that the target second-level data pointer table does not exist, or that the target second-level data pointer table exists but is invalid, allocating one second-level data pointer table in the plurality of second-level data pointer tables and updating location information of the allocated second-level data pointer table to the first-level data pointer table; and
writing the data into the source data volume and updating the write location of the data to the allocated second-level data pointer table.

12. The electronic device according to claim 9, wherein the at least one processor is caused to further perform:
after the snapshot is recreated, before data is written into the source data volume, detecting whether a second-level data pointer table in which the written new data is located already exists;
in response to determining that the second-level data pointer table in which the written new data is located does not exist, creating a second-level data pointer table corresponding to the new data; and
writing the new data into the source data volume and modifying a pointer item in the created second-level data pointer table to point to the new data.

13. The electronic device according to claim 12, wherein the at least one processor is caused to further perform:
in response to determining that the second-level data pointer table in which the written new data is located exists, copying the second-level data pointer table to obtain a newly-created second-level data pointer table, and modifying a first-level data pointer table item of the source data volume to enable the modified first-level data pointer table item of the source data volume to point to the newly-created second-level data pointer table;
looking up, in the newly-created second-level data pointer table, whether a data block corresponding to the new data is already allocated; and
in response to determining that the data block corresponding to the new data is already allocated, copying original data in the source data volume, merging the original data and the new data, writing merged data into the source data volume, and updating the newly-created second-level data pointer tables in the source data volume to enable the updated second-level data pointer table in the source data volume to point to the merged data block.

14. The electronic device according to claim 13, wherein the at least one processor is caused to further perform:
in response to determining that the data block corresponding to the new data is not allocated, directly writing the new data into the source data volume and updating location information of the new data to the newly-created second-level data pointer table of the source data volume.

15. The electronic device according to claim 9, wherein the at least one processor is caused to further perform:
when the data is read, determining a second-level data pointer table in which a reading location is located according to the first-level data pointer table of the source data volume or the first-level data pointer table of the snapshot, determining, from the second-level data pointer table in which the reading location is located, a location of the read data, and reading the data from the location.

16. The electronic device according to claim 9, wherein the at least one processor is caused to further perform:
deleting the snapshot by directly deleting the first-level data pointer table of the snapshot.

17. A non-transitory computer-readable storage medium storing computer instructions which, when executed by a processor, are configured to cause the processor to perform the method for fast generating a full snapshot according to claim 2.

18. A non-transitory computer-readable storage medium storing computer instructions which, when executed by a processor, are configured to cause the processor to perform the method for fast generating a full snapshot according to claim 3.

19. A non-transitory computer-readable storage medium storing computer instructions which, when executed by a processor, are configured to cause the processor to perform the method for fast generating a full snapshot according to claim 4.

20. A non-transitory computer-readable storage medium storing computer instructions which, when executed by a processor, are configured to cause the processor to perform the method for fast generating a full snapshot according to claim 5.
